(19) United States
(12) Patent Application Publication
(10) Pub. No.: US 2010/0237524 A1
(43) Pub. Date: Sep. 23, 2010

(54) METHOD OF MANUFACTURING CERAMIC CAPABLE OF ADSORBING FRAGRANCE AND RELEASING FRAGRANT AROMA

(76) Inventor: VICKI CHEN, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/791,220

(22) Filed: Jun. 1, 2010

Related U.S. Application Data
(63) Continuation-in-part of application No. 11/790,469, filed on Apr. 25, 2007.

(51) Int. Cl. B28B 17/00; B28B 11/08; B28B 1/24

(52) U.S. Cl. 264/39; 264/40.1

(57) ABSTRACT

A method of manufacturing a ceramic capable of adsorbing a fragrance and releasing a fragrant aroma primarily mixes over 60% of a metal oxide with a ceramic clay, and then produces a lubricating effect by performing a high-temperature thermal treatment to the ceramic clay in a liquid form between the metal oxide particles in a solid form, such that the metal oxide particles can serve as sliding carriers and provide an enhanced effect for manufacturing a ceramic product with a fine surface and an internal porous property, and provide good adsorption rate and release effect of the fragrance.

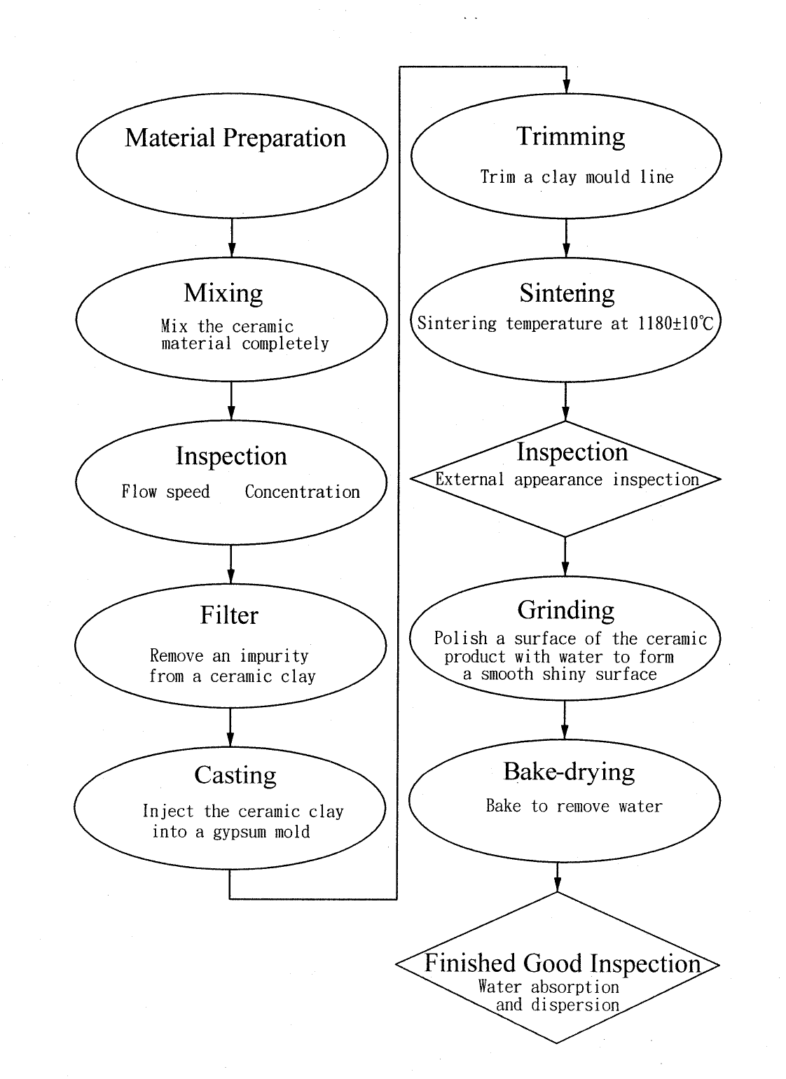

This application is a Continuation-In-Part Application of Ser. No. 11/790,469, filed on Apr. 25, 2007, and entitled “AROMA PORCELAIN DIFFUSER”, now pending.

### BACKGROUND OF THE INVENTION

1. Field of the Invention

The present invention relates to a ceramic manufacturing method, and more particularly to a method of manufacturing a ceramic capable of adsorbing a fragrance and releasing a fragrant aroma.

2. Description of the Related Art

In general, an air freshener for migrating and improving unpleasant odors in indoor spaces primarily releases a fragrance into air by a burning or spraying method. However, it is necessary to spray the fragrance manually and repeatedly to maintain the fresh odor indoors, after the fragrance has been converted into a misty form, sprayed into the air, and vaporized. Obviously, such application is relatively troublesome and inconvenient. The burning method exists a hidden risk of catching fire.

At present, some products available in the market use clay for dispersing fragrant aroma. Although clay products have a better water absorption for absorbing fragrance than the high-temperature ceramic products, the surface of the clay is rough and difficult for molding. Clay cannot achieve a fine surface effect as good as the high-temperature ceramic products, and the hardness of the clay products is not as good as the high-temperature ceramic products, and the clay products are fragile. On the other hand, the ceramic products come with the advantages of a fine surface and a high hardness, but the water absorption is below 0.5%, which is unsuitable to be used as a medium for absorbing fragrance.

### SUMMARY OF THE INVENTION

Therefore, it is a primary objective of the present invention to provide a method of manufacturing a ceramic capable of adsorbing a fragrance and releasing a fragrant aroma, and the ceramic has the advantages of convenience and good appearance.

To achieve the foregoing objective, the present invention provides a method of manufacturing a ceramic capable of adsorbing a fragrance and releasing a fragrant aroma, and the method comprises the following steps:

(a) Material preparation step: Prepare over 60% metal oxide as a substrate, and add an appropriate quantity of ceramic clay to form a ceramic material, wherein the metal oxide is comprised of an aluminum oxide (Al₂O₃);

(b) Mixing step: Put the ceramic material into a grinding machine for a predetermined grinding time to fuse each element in the ceramic material to produce a slurry ceramic clay;

(c) Inspection step: Inspect the ceramic clay to determine whether or not the slurry ceramic clay is uniform;

(d) Filtering step: Filter an extra impurity in the ceramic clay by a sieve;

(e) Casting step: Inject the filtered ceramic clay into a mold with a predetermined stylish shape, remove extra ceramic clay from the mold after the mold adsorbs the ceramic clay and coats the ceramic clay to a predetermined thickness, form a ceramic clay body in a predetermined stylish shape after a wait time is finished, and then remove the ceramic clay body from the mold;

(f) Sintering step: Dry the ceramic clay body removed from the mold, and then place and heat the ceramic clay body in a heat treatment kiln, and control a sintering temperature at 1180±10° and a sintering time of approximately 8˜10 hours to manufacture a ceramic product with a fine surface and an internal porous property, such that the ceramic product is capable of adsorbing the fragrance and releasing the fragrant aroma.

The metal oxide is comprised of SiO₂ (34.96%), Al₂O₃ (60.5%), Fe₂O₃ (0.1%), TiO₂ (0.04%), CaO (0.25%), MgO (0.02%), K₂O (0.82%), and Na₂O (0.7%).

### BRIEF DESCRIPTION OF THE DRAWING

The FIGURE is a flow chart of a manufacturing procedure of the present invention.

### DETAILED DESCRIPTION OF THE PREFERRED EMBODIMENTS

With reference to the FIGURE for a flow chart of a method of manufacturing a ceramic capable of adsorbing a fragrance and releasing a fragrant aroma the present invention, the method comprises the following steps:

(a) Material preparation step: Prepare over 60% metal oxide as a substrate, and add an appropriate quantity of ceramic clay and a dye with a predetermined color to form a ceramic material, wherein the metal oxide is comprised of SiO₂ and Al₂O₃. In this preferred embodiment, the metal oxide is comprised of SiO₂ (34.96%), Al₂O₃ (60.5%), Fe₂O₃ (0.1%), TiO₂ (0.04%), CaO (0.25%), MgO (0.02%), K₂O (0.82%), Na₂O (0.7%), and the remaining 2.61% is an error occurred during the mixing and refining the raw materials;

(b) Mixing step: Put the ceramic material into a grinding machine for a grinding time of approximately 12 to fuse each element in the ceramic material to produce a slurry ceramic clay;

(c) Inspection step: Perform a speed flow inspection and a concentration inspection to the ceramic clay to determine whether or not the slurry ceramic clay is uniform before the following steps take place;

(d) Filtering step: Filter an extra impurity in the ceramic clay by passing the ceramic clay through a shaking 100-mesh sieve, in order to assure the particle size of the ceramic clay and enhance the product quality;

(e) Casting step: Inject the filtered ceramic clay into a gypsum mold with a predetermined stylish shape, remove extra ceramic clay from the mold after the mold adsorbs the ceramic clay and coats the ceramic clay to a predetermined thickness, form a ceramic clay body in a predetermined stylish shape after a wait time is finished, remove the ceramic clay body from the gypsum mold, and trim a clay mold line according to an actual requirement; and

(f) Sintering step: Dry the ceramic clay body removed from the gypsum mold, and then place and heat the ceramic clay body in a heat treatment kiln, and control a sintering temperature at 1180±10° and a sintering time of approximately 8˜10 hours to manufacture a ceramic product with a fine surface and an internal porous property, such that the ceramic product is capable of adsorbing the fragrance and releasing the fragrant aroma.

After the ceramic product is manufactured by the aforementioned steps in accordance with the present invention, an external appearance inspection step is performed to the ceramic product to inspect whether or not the ceramic product is broken or damaged, and then a grinding step is performed to the ceramic product to polish a surface of the ceramic product with water to form a smooth shiny surface, and then a bake-drying step is performed to dry the ceramic product, and finally a finished good inspection is performed to the ceramic product to confirm whether or not the water absorption and dispersion are in compliance with the product requirements.

The ceramic material of the present invention is comprised of a metal oxide (aluminum oxide, Al₂O₃) with a high melting point as a solid substrate, and a ceramic clay with a lower melting point as a liquid material, such that when the solid substrate is processed by the sintering process, the powder particles in the ceramic material at a preliminary stage are in contact with each other, and a neck of each powder particle is grown to a particle diameter of approximately 20%, which is called a preliminary sintering stage, and the preliminary sintering stage has a maximum shrinkage rate of 4˜5%, and a particle boundary at a middle stage is expanded, and the neck is grown till the particle boundary is moved to result in a crystal growth deformation, and pores at the crystal boundary becomes a continual tubular shape to form a network, and the middle stage has a shrinkage rate of approximately 5˜20% and a density of 95%. In addition, the liquid material provides a specific strength to the clay body, and the pores in the substrate provide a porous property at the crystal boundary to achieve the effects of adsorbing the fragrance and releasing the fragrant aroma.

The ceramic product manufactured in accordance with the present invention has a water absorption of approximately 17.79±0.01%, and a porosity of approximately 25.66±0.01%. The following table shows the difference between the water absorptions of the present invention and a general ceramic and clay product.

| | The present | General High | Semi | Porcelain |
|---|---|---|---|---|
| | invention | Temperature Ceramic | Ceramic | Clay |
| Water | 17.79% | 0.5% | 5%~8% | Over 8% |
| Absorption | | | | |

The absorption property of the pores densely distributed in the interior and on the surface of the ceramic product manufactured in accordance with the present invention provides the capability of adsorbing a large quantity of fragrance and releasing the fragrant aroma. The invention increases the contact area between the fragrance and air to achieve the long-lasting fragrant effect, and skips the inconvenient pressing or burring method of the conventional air fresheners to achieve a better dispersion effect and a higher dispersion performance. The convenient application allows manufacturers to produce the ceramic products with a size and a shape that fits an indoor space and provide more diversifications to the external appearance of the product.

What is claimed is:

1. A method of manufacturing a ceramic capable of adsorbing a fragrance and releasing a fragrant aroma, comprising:
(a) a material preparation step, preparing over 60% metal oxide as a substrate, and adding an appropriate quantity of ceramic clay to form a ceramic material, and the metal oxide being comprised of an aluminum oxide (Al₂O₃);
(b) a mixing step, putting the ceramic material into a grinding machine for a predetermined grinding time to fuse each element in the ceramic material to produce a slurry ceramic clay;
(c) an inspection step, inspecting the ceramic clay to determine whether or not the slurry ceramic clay is uniform;
(d) a filtering step, filtering an extra impurity in the ceramic clay by a sieve;
(e) a casting step, injecting the filtered ceramic clay into a mold with a predetermined stylish shape, removing extra ceramic clay from the mold after the mold adsorbs the ceramic clay and coats the ceramic clay to a predetermined thickness, and forming a ceramic clay body in a predetermined stylish shape after a wait time is finished, and then removing the ceramic clay body from the mold;
(f) a sintering step: drying the ceramic clay body removed from the mold, and then placing and heating the ceramic clay body in a heat treatment kiln, and controlling a sintering temperature at 1180±10°, and a sintering time of approximately 8˜10 hours, to manufacture a ceramic product with a fine surface and an internal porous property and capable of adsorbing the fragrance and releasing the fragrant aroma.

2. The method of manufacturing a ceramic capable of adsorbing a fragrance and releasing a fragrant aroma as recited in claim 1, wherein the metal oxide is comprised of SiO₂ (34.96%), Al₂O₃ (60.5%), Fe₂O₃ (0.1%), TiO₂ (0.04%), CaO (0.25%), MgO (0.02%), K₂O (0.82%) and Na₂O (0.7%)

3. The method of manufacturing a ceramic capable of adsorbing a fragrance and releasing a fragrant aroma as recited in claim 1, wherein the ceramic material contains an aluminum oxide (Al₂O₃) with a high melting point as a solid substrate, and a ceramic clay with a lower melting point as a liquid material, such that when the solid substrate is processed by the sintering process, the powder particles in the ceramic material at a preliminary stage are in contact with each other, and a neck of each powder particle is grown to a particle diameter of approximately 20%, which is called a preliminary sintering stage, and the preliminary sintering stage has a maximum shrinkage rate of 4˜5%, and a particle boundary at a middle stage is expanded, and the neck is grown till the particle boundary is moved to result in a crystal growth deformation, and pores at the crystal boundary becomes a continual tubular shape to form a network, and the middle stage has a shrinkage rate of approximately 5˜20% and a density of 95%.

4. The method of manufacturing a ceramic capable of adsorbing a fragrance and releasing a fragrant aroma as recited in claim 1, wherein the ceramic material further includes a dye of a predetermined color added into the ceramic material.

5. The method of manufacturing a ceramic capable of adsorbing a fragrance and releasing a fragrant aroma as recited in claim 1, wherein the grinding step takes a grinding time of approximately 12 hours to completely fuse each element in the ceramic material.

6. The method of manufacturing a ceramic capable of adsorbing a fragrance and releasing a fragrant aroma as recited in claim 1, wherein the inspection step performs a flow speed inspection and a concentration inspection to the ceramic clay.

7. The method of manufacturing a ceramic capable of adsorbing a fragrance and releasing a fragrant aroma as recited in claim 1, wherein after the casting step takes place, a clay mold line is trimmed according to a requirement.

8. The method of manufacturing a ceramic capable of adsorbing a fragrance and releasing a fragrant aroma as recited in claim 1, wherein after the ceramic product is manufactured, an external appearance inspection step is performed to the ceramic product to inspect whether or not the ceramic product is broken or damaged, and then a grinding step is performed to the ceramic product to grind the ceramic product with water to polish and form a smooth shiny surface, and then a bake drying step is performed to bake dry the water; and finally a finished good inspection is performed to the ceramic product to confirm a water absorption and a water dispersion of the ceramic product.
